(19) United States
(12) Patent Application Publication
(10) Pub. No.: US 2008/0198029 A1
(43) Pub. Date: Aug. 21, 2008

(54) Method for searching position of electronic component

(75) Inventor: Cheng-Hsun Ho, Taipei (TW)

Correspondence Address: RABIN & Berdo, PC, 1101 14TH STREET, NW, SUITE 500, WASHINGTON, DC, 20005, US

(73) Assignee: INVENTEC CORPORATION, Taipei (TW)

(21) Appl. No.: 11/706,344

(22) Filed: Feb. 15, 2007

(51) Int. Cl. G08B 21/00

(52) U.S. Cl. 340/686.1

(57) ABSTRACT

A method for searching a position of an electronic component is provided. A coordinate value is computed based on the position of the electronic component during the placement process of the electronic component in a circuit diagram. Then, the computed coordinate value is combined with a symbol of the electronic component to produce a position serial number. The position serial number is stored in a database. Therefor, if the layout software receives a search command, the position serial number corresponding to the search command is searched out from the database, and a coordinate block matched to the position serial number is circled. Therefore, the convenience for using the circuit diagram is promoted.

### BACKGROUND OF THE INVENTION

1. Field of the Invention

The present invention relates to a method for searching a position of an electronic component in a circuit diagram, and more particularly to a method where the information of the position of an electronic component is added so that the position of the electronic component can be fast searched.

2. Related Art

Layout design plays an important role in the early stage of designing a printed circuit board (PCB), wherein using a computer to design the layout of the PCB can be mainly divided into two parts. One is the placement process in preceding phase and the other is the circuit design process in later phase.

Presently, after the placement process is finished, a circuit design engineer will mark beside the component about the component's attribute and number, for example, such as R1 or C1 and so on, so that when the circuit design engineer is trying to check components on by one or study the circuit diagram, he/she can clearly understand the attribute and the number of the component. However, when the circuit design engineer has to check a complicated circuit diagram, the searching efficiency of the searched component must depend on the experiences and memories of the circuit design engineer who may know in which block of the circuit diagram the component can be found. On the other hand, for new recruits or less experienced circuit design engineers, they must spend a lot of time for searching the component.

### SUMMARY OF THE INVENTION

According to the abovementioned problems, the purpose of the present invention is to provide a method for searching a position of an electronic component, where the coordinate value of an electronic component will be generated during is the placement process, and the coordinate value of the electronic component will be stored in a database. Therefore, the electronic component can be fast searched based on the name and the coordinate value of the electronic component.

According to the present invention, the method for searching a position of an electronic component may apply to a circuit diagram, and the method comprises the steps of: First, an electronic component is selected; a layout software receives a component placing command and places the electronic component on a selected position of the circuit diagram. In addition, the circuit diagram has a plurality of coordinate blocks, and each coordinate block has an x-axis coordinate number and a y-axis coordinate number; a computer performs a coordinate calculation for the selected position to obtain a coordinate value which includes an x-axis coordinate number and a y-axis coordinate number; the layout software combines the symbol of the electronic component with the coordinate value to obtain a position serial number; and then the layout software stores the position serial number to the database.

On the other hand, when the layout software receives a searching command input by a user, the layout software will search the corresponding position serial number in the database based on the searching command. If a position serial number corresponding to the searching command is obtained and confirmed, the coordinate block where the position serial number belongs in will be circled by using a different color frame, or the electronic component which corresponds to the position serial number will be marked with different color. However, if a position serial number is not matched to the searching command, the next position serial number is compared.

By the method for searching a position of an electronic component, the information about the position of an electronic component is added when the electronic component is placed on a circuit diagram and then the position information will be stored into a database with the symbol of the electronic component. Therefore, once a user inputs a searching command, the electronic component corresponding to the searching command can be fast marked. Besides, the circuit design engineer or the R&D engineer can also determine whether the quantities of the electronic component in the coordinate block in conformity with the design requirement according to the positions of the marked electronic component, so that they can instantaneously check and modify the wiring, thereby the convenience of the circuit diagram can be enhanced for both the circuit design engineer and the R&D engineer.

The features and practice of the preferred embodiments of the present invention will be illustrated below in detail with reference to the drawings.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given below, which is for illustration only and thus is not limitative of the present invention, wherein:

FIG. 1A shows a flowchart of an illustrative embodiment of the present invention;

FIG. 1B is a flow chart of an illustrative embodiment of the present invention showing the process of fast searching a position of an electronic component;

FIG. 2 shows the placement of the electronic component according to the illustrative embodiment of the invention;

FIG. 3 is an enlarged view of the coordinate block in FIG. 2; and

FIG. 4 shows the placement of the electronic component according to the illustrative embodiment of the present invention.

### DETAILED DESCRIPTION

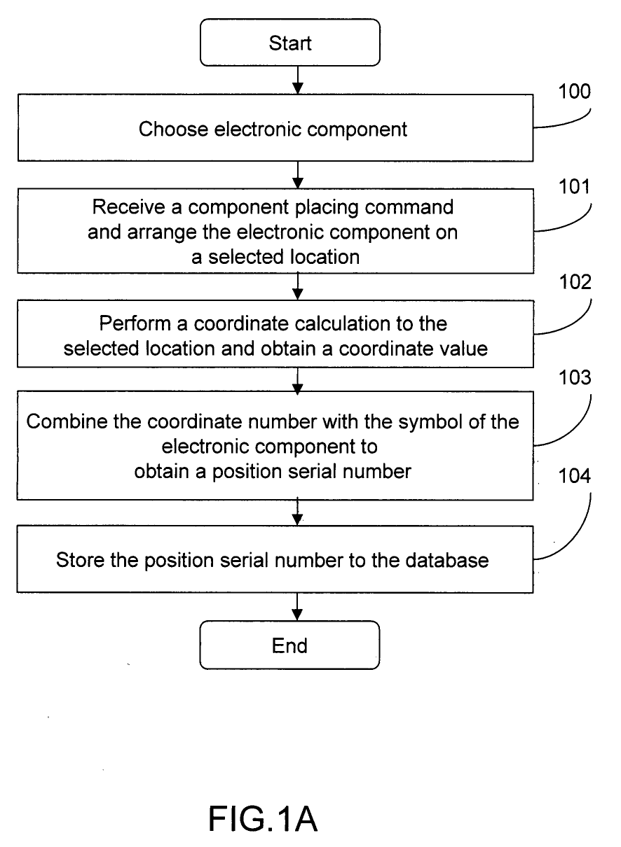

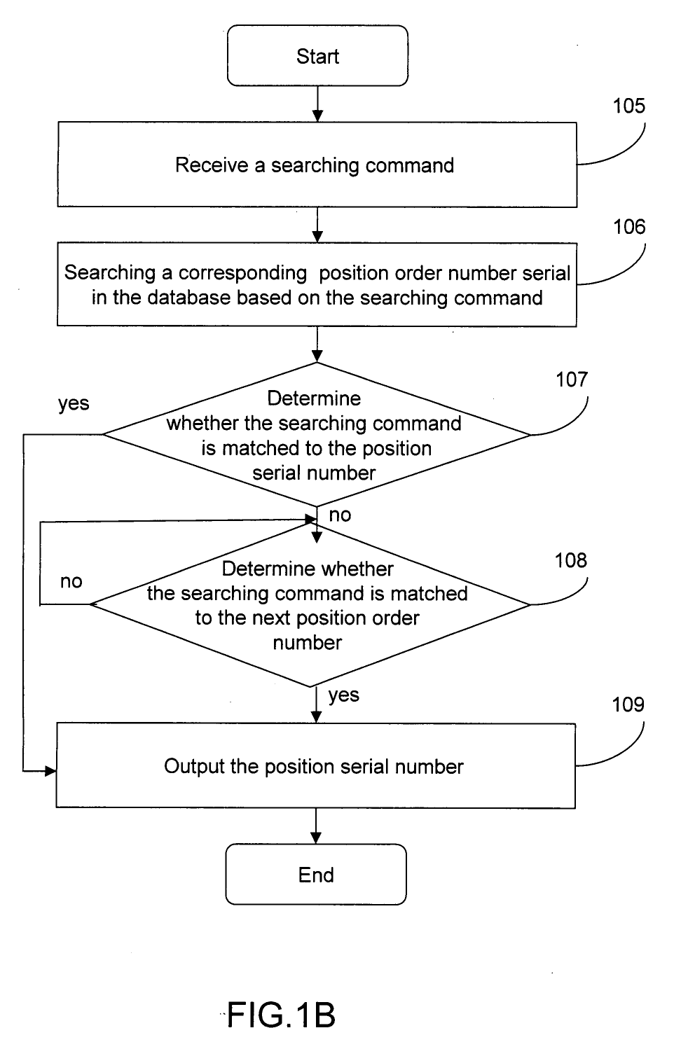

FIG. 1A shows a flowchart of an illustrative embodiment of the present invention. As shown in the figure, a method for searching a position of an electronic component can be applied to a circuit diagram including a plurality of circuit function groups. The circuit diagram has a plurality of coordinate blocks, and each coordinate block is constituted by vertical and horizontal lines crossing to each other. In addition, each coordinate block has an x-axis coordinate number and a y-axis coordinate number.

At the beginning, in the circuit design process, a user may select an electronic component to place on the circuit diagram. When an electronic component is selected (step 100), a computer will read a symbol data of the selected electronic component from its database, and then display the symbol in the circuit diagram. Then, the user inputs a component placing command, so that the electronic component is placed at the selected position of the circuit diagram (step 101).

After the step 101, the computer will perform a coordinate calculation based on the selected position in the circuit diagram in order to obtain a coordinate value (step 102). Wherein, the coordinate calculation is performed to obtain the x-axis coordinate number and the y-axis coordinate number of the selected position based on the coordinate block to which the selected position is located. As to the knowledge of a person skilled in the art, the coordinate value can be displayed in a manner like “x-axis coordinate number, y-axis coordinate number” or “y-axis coordinate number, x-axis coordinate number”, but it is not limited to these.

When the circuit design engineer placed an electronic component, the attribute of the electronic component usually will be marked beside it, such as “R” for resistor, “C” for capacitor, “D” for diode, “Q” for transistor, “L” for inductance and so on, and when a number is included, it will be like “R1”, “C1” or “M1”. Hereafter, such as “R1”, “C1” or “M1” will be called as the symbol of the electronic component. Therefore, after the coordinate value is obtained, the layout software will combine the symbol of the electronic component and the coordinate value to generate a position serial number (step 103). Wherein, the position serial number can be displayed in a manner like “coordinate value, symbol of the electronic component” or “symbol of the electronic component, coordinate value”, but it is not limited to these.

After the position serial number is obtained, the layout software will store the position serial number to the database (step 104). Thus, every time when an electronic component is placed by the circuit designer engineer, a position serial number consisting of the symbol of the electronic component and the coordinate value will be automatically generated.

FIG. 1B is a flow chart of an illustrative embodiment of the present invention showing the process of fast searching a position of an electronic component. FIG. 1B continues the step 104 of FIG. 1A, where when a user is trying to search a position of an electronic component in the circuit diagram, a searching command is inputted by the user and the searching command will be received by the computer (step 105) for searching the position of the electronic component in the circuit diagram. The searching command can be at least one of a y-axis coordinate number, an x-axis coordinate number, a symbol of an electronic component, and a quantity of the electronic component. Furthermore, the searching command can be processed through the logic operation instruction such as AND operation instruction or OR operation instruction, to perform a more precise electronic component position searching.

Then, the layout software will search a corresponding position serial number in the database according to the searching command inputted by the user (step 106). Where, in the step 106, whether the searching command is matched to a corresponding position serial number is firstly determined (step 107). In the other words, since the searching command inputted by the user can be only an x-axis coordinate number, a y-axis coordinate number, or a symbol of the electronic component, therefore, any block corresponds to the searching command inputted will be circled or marked. Hence, a row of the blocks or a line of the blocks in the circuit diagram may possibly be marked.

Besides, if a user inputs a searching command containing an x-axis coordinate number and a y-axis coordinate number, only the block which corresponds to the searching command can be circled. In addition, if the user inputs a searching command containing a symbol of the electronic component only, the layout software may mark the block on which the electronic component is located, such as circling the whole block or shifting the block to the center of screen for helping user to identify small electronic components.

In the illustrative embodiments of the present invention, the way to mark a block can be circling the frame of the block with a color. Also the electronic components in the block are displayed with different colors, but it is not limited to these.

Furthermore, when it is determined that the searching command is matched to a corresponding position serial number, the position serial number will be outputted (step 108). The way to output the position serial number depends on the contents of the searching command (as described above), but it is not limited to those.

The comparison of the searching command with a corresponding position serial number is implemented by means of comparing the searching command with all of the position serial numbers in the database. If a position serial number corresponding to the searching command is found, the position serial number will be outputted (step 109); otherwise, the comparing process will continue.

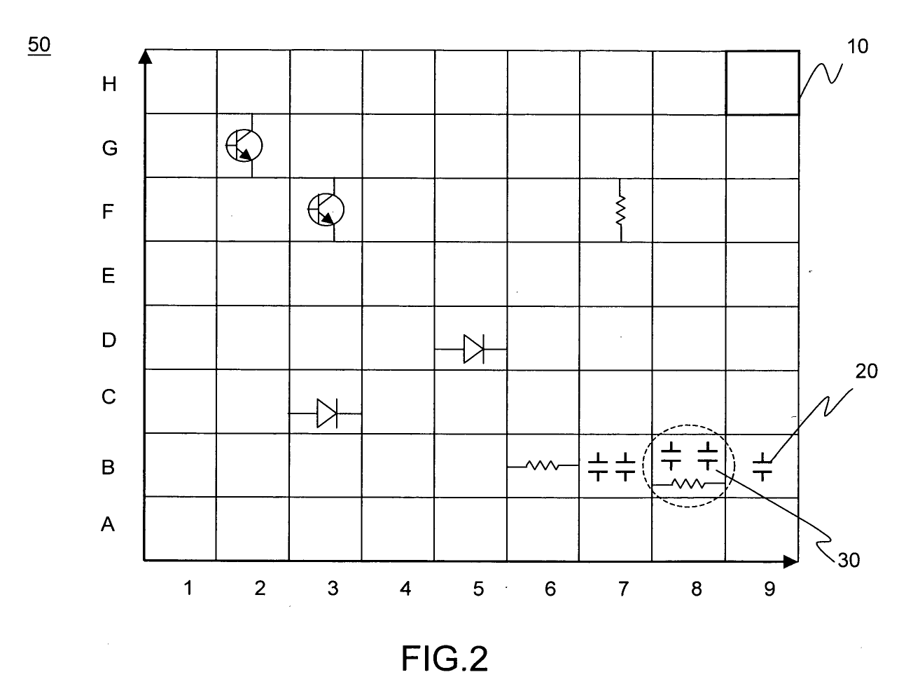

FIG. 2 shows the placement of the electronic component according to the illustrative embodiment of the present invention. First, a user may choose a variety of electronic components 20, and place them in the circuit diagram 50. The circuit diagram 50 may have a plurality of coordinate blocks 10 which are constituted by a plurality of vertical and horizontal lines crossing each other. In addition, every block 10 includes a corresponding x-axis coordinate number, such as 1, 2, 3, 4, 5, 6, 7, 8, 9 and so on and a corresponding y-axis coordinate number, such as A, B, C, D, E, F, G, H, and so on. When an electronic component 20 is placed in a block 10 of the circuit diagram 50, the computer will proceed a coordinate calculation according to the coordinate block 10 to obtain a coordinate value.

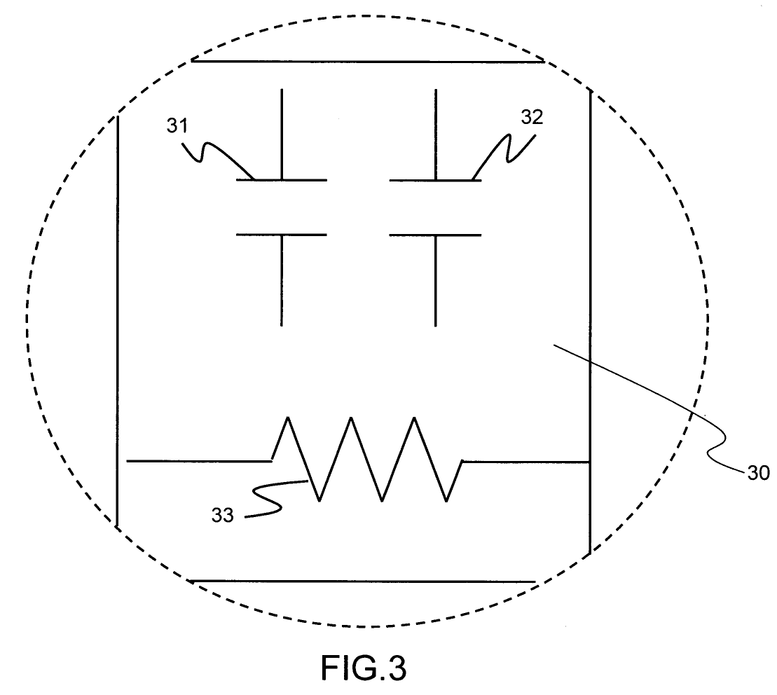

Take a coordinate block 30 shown in FIG. 3, which is an enlarged view of the block 30 in FIG. 2 as an example. In the coordinate block 30, it includes a first capacitor component 31, a second capacitor component 32, and a first resistor component 33, where the symbol of the electronic component “C” indicates the first capacitor component 31, and “8B” is the coordinate value of the first capacitor component 31. Therefore, after the coordinate calculation, the position serial number “C8B” can be obtained to represent the first capacitor component 31. The same, the position serial number “C8B” can be obtained to represent the second capacitor component 32, and the position serial number “R8B” can be obtained to represent the first resistor component 33.

In addition, the position serial number in an embodiment of the present invention can further include the information about the quantity of the electronic component, so that a user can obtain information about the quantity of the electronic component in the specify coordinate block. In other words, the quantity of the components is a number for one of the circuit function groups to which the electronic component belongs. Thus, after the information of the quantity of the electronic component is added to the position serial number, the position serial number of the first capacitor component 31 in FIG. 3 will become “C8B1”. The same, the second capacitor component 32 will have the position serial number of “C8B2” and the first resistor component 33 will have a position serial number of “R8B1”. In other words, the first digit of the position serial number indicates the symbol of the electronic component, the second and third digits indicate the coordinate value of the electronic component, and the fourth digit indicates the quantity of the electronic component. And the position serial number described above will be combined with the information of the electronic component and be stored in the database.

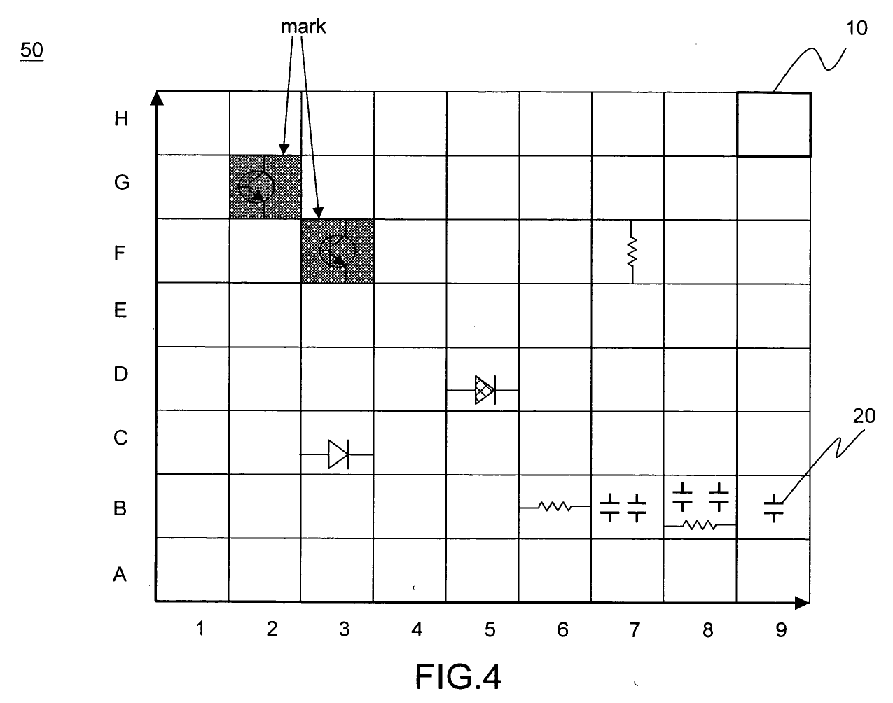

Then, when a user is trying to search the position of an electronic component in the circuit diagram 50, such as a transistor, the user may input a searching command such as a symbol of the electronic component “Q”. Once the layout software receives the searching command “Q”, the layout software will be executed to search a corresponding position serial number in the database. When it is determined that there exists a position serial number which corresponds to the searching command “Q”, the computer can use a different color circling the frame of the block in which the position serial number complies with in the circuit diagram 50 as shown in FIG. 4, or can use a different color to display the electronic component which complies with the position serial number.

In summary, the method for searching a position of an electronic component of the present invention can allow a user to fast search and mark the position of a required electronic component after the user input a searching command. Therefore, a circuit design engineer can determine whether the quantity of the electronic component in the coordinate block complies with the circuit design requirement based on the marked position of the electronic component, by which they can check and determine whether to modify so that the convenience of the circuit diagram can be improved.

While the illustrative embodiments of the present invention have been set forth for the purpose of disclosure, modifications of the disclosed embodiments of the invention as well as other embodiments thereof may occur to those skilled in the art. Accordingly, the appended claims are intended to cover all embodiments, which do not depart from the spirit and scope of the invention

What is claimed is:

1. A method for searching a position of electronic component by a user, suitable for applying to a circuit diagram, comprising:
the user selecting an electronic component;
receiving a component placing command and placing the electronic component on a selected position;
performing a coordinate calculation to the selected position to obtain a coordinate value;
combining the coordinate value with an electronic component symbol to obtain a position serial number; and
storing the position serial number into a database.

2. The method for searching a position of an electronic component as claimed in claim 1, further comprising following steps:
receiving a searching command;
searching the corresponding position serial number in the database based on the searching command; and
outputting the position serial number.

3. The method for searching a position of an electronic component as claimed in claim 2, wherein the circuit diagram has a plurality of coordinate blocks, and each coordinate block has an x-axis coordinate number and a y-axis coordinate number.

4. The method for searching a position of an electronic component as claimed in claim 3, wherein the coordinate calculation is based on one of the coordinate blocks on which the selected position is located to obtain the x-axis coordinate number and the y-axis coordinate number of the selected position.

5. The method for searching a position of an electronic component as claimed in claim 4, wherein the coordinate value includes the x-axis coordinate number and the y-axis coordinate number.

6. The method for searching a position of an electronic component as claimed in claim 5, wherein the step of searching the corresponding position serial number in the database based on the searching command comprising:
determining whether the searching command is matched to the position serial number;
outputting the position serial number when the searching command is matched to the position serial number; and
determining whether the position serial number is matched to a next position serial number if the searching command is not matched to the position serial number.

7. The method for searching a position of an electronic component as claimed in claim 5, wherein the searching command includes at least one of the x-axis coordinate number, the y-axis coordinate number, and the electronic component symbol.

8. The method for searching a position of an electronic component as claimed in claim 3, wherein the step of outputting the position serial number includes a step of using different colors to circle frame of the coordinate block on which the position serial number is located.

9. The method for searching a position of an electronic component as claimed in claim 3, wherein the step of outputting the position serial number includes a step of using different colors to mark the electronic component to which the position serial number corresponds.

10. The method for searching a position of an electronic component as claimed in claim 1, wherein the position serial number further includes a quantity of the electronic component.

11. The method for searching a position of an electronic component as claimed in claim 10, wherein the circuit diagram includes a plurality of circuit function groups.

12. The method for searching a position of an electronic component as claimed in claim 11, wherein the quantity of the electronic component is a number for one of the circuit function groups to which the electronic component belongs.
